(19) United States
(12) Patent Application Publication
(10) Pub. No.: US 2008/0050974 A1
(43) Pub. Date: Feb. 28, 2008

(54) Multi-directional electrical interconnect device

(76) Inventor: Andrew D. Delano, Spokane, WA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/510,986

(22) Filed: Aug. 27, 2006

(51) Int. Cl. H01R 24/00

(52) U.S. Cl. 439/660

(57) ABSTRACT

A multi-directional electrical interconnect device having mating male and female terminals disposed in, attached to, or coupled to male and female housings. The housings and terminals are configured to allow mating at any angle between two orthogonal directions, i.e., from either of two directions that are disposed at 90 degrees relative to one another, or any angle therebetween.

### BACKGROUND

The present invention relates to electrical interconnection devices and apparatus employing same.

The assignee of the present invention designs and manufactures computing systems, including personal computers, servers and imaging devices, and the like. One such computing device is implemented using multiple processors, i.e., microprocessors or central processing units (CPUs).

This particular computing device utilizes eight substantially identical 172 mm fans to cool the processors and other components. Depending on its location, a fan may be installed by sliding it in from the side or by dropping it down from the top. Each fan is housed in a module which would be most desirably electrically interconnected using the same electrical connector to minimize design and manufacturing costs.

Ideally, a single fan module which can be plugged in either from the side or top without rotating the fan is desirable. However, there are currently no connectors that allow multi-directional plug-in. Conventional practice would require fan module designs that utilize at least two different connectors, one for each direction.

It would be desirable to have a electrical interconnect device that allows multi-directional plug-in capability.

### BRIEF DESCRIPTION OF THE DRAWINGS

The various features and advantages of disclosed embodiments may be more readily understood with reference to the following detailed description taken in conjunction with the accompanying drawings, wherein like reference numerals designate like structural elements, and in which:

FIG. 1 illustrates a portion of an exemplary computing system employing a multi-directional electrical interconnect device;

FIG. 1a is a cross-sectional view through a portion of the computing system showing exemplary multi-directional electrical interconnect devices'

FIG. 2 illustrates an exemplary multi-directional electrical interconnect device that may be used in the exemplary computing system; and

FIG. 3 is another view of the exemplary multi-directional electrical interconnect device shown in FIG. 2.

### DETAILED DESCRIPTION

The multi-directional electrical interconnect device discussed below is generally described with regard to its use with a computing system. However, it is to be understood that the multi-directional electrical interconnect device described herein is also well-suited for use other types of electronic and electrical equipment, including scanners, displays and projectors, digital imaging devices, and the like, and is not limited to use in computing systems.

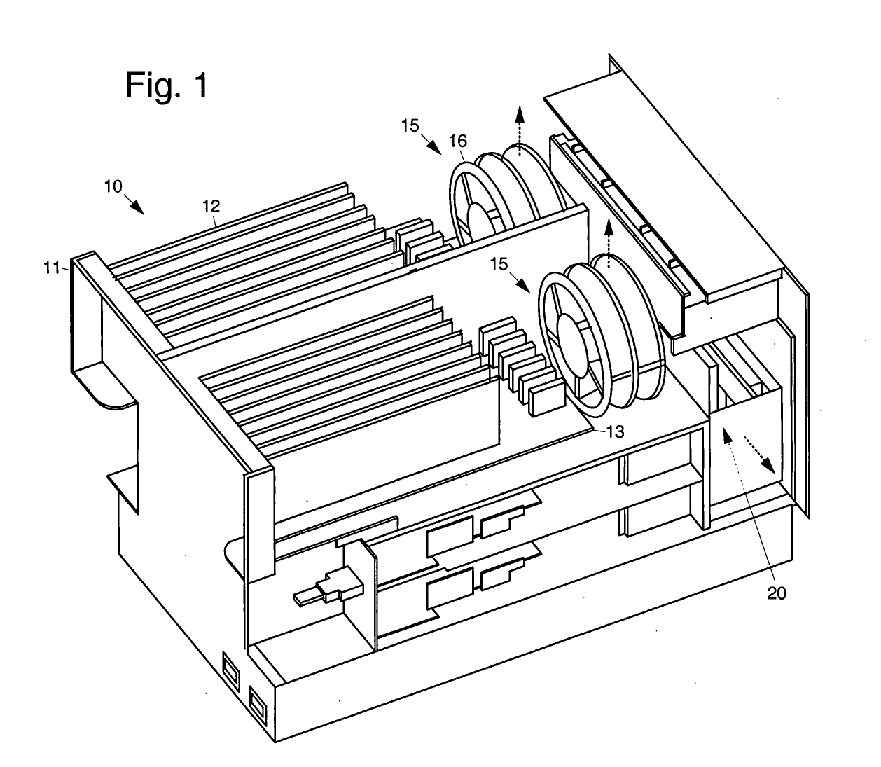

Referring to the drawing figures, FIG. 1 illustrates a portion of an exemplary computing system 10 employing a plurality of multi-directional electrical interconnect devices 20. The multi-directional electrical interconnect devices 20 are disposed inside the computing system 10 hidden from view in FIG. 1. FIG. 1a is a cross-sectional view through a portion of the computing system 10 showing exemplary multi-directional electrical interconnect devices 20.

The exemplary computing system 10 comprises a processor housing 11 that houses a plurality of processor cards 12 containing multiple processors, i.e., microprocessors or central processing units (CPUs). The plurality of processor cards 12 containing the processors are connected to a circuit board 13. Various other circuit boards and connectors are also contained in the computing system 10. The exemplary computing system 10 comprises a fan module 15 that houses a plurality of fans 16 that are used to cool the processors and other components of the computing system 10. The fan module 15 comprises one or more multi-directional electrical interconnect devices 20 that allow connection to a power source (not shown).

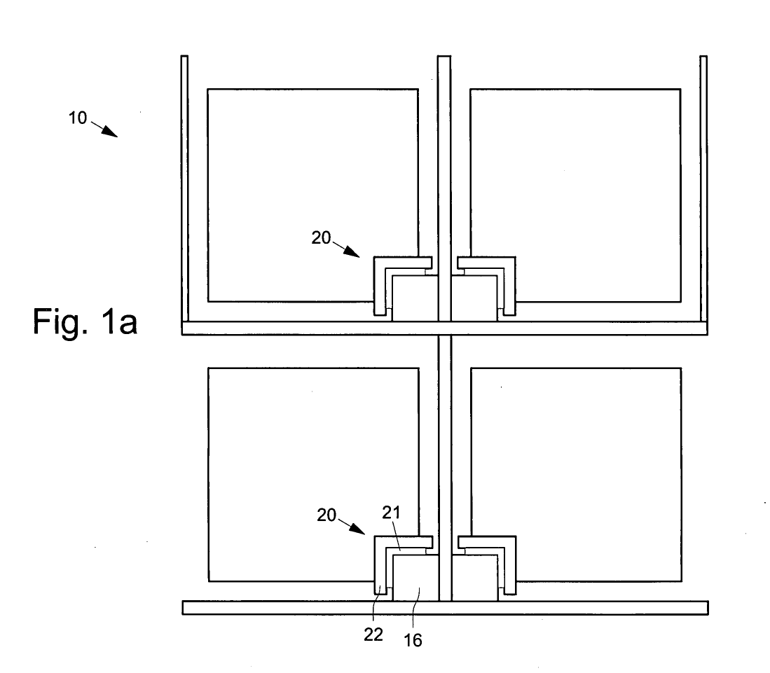

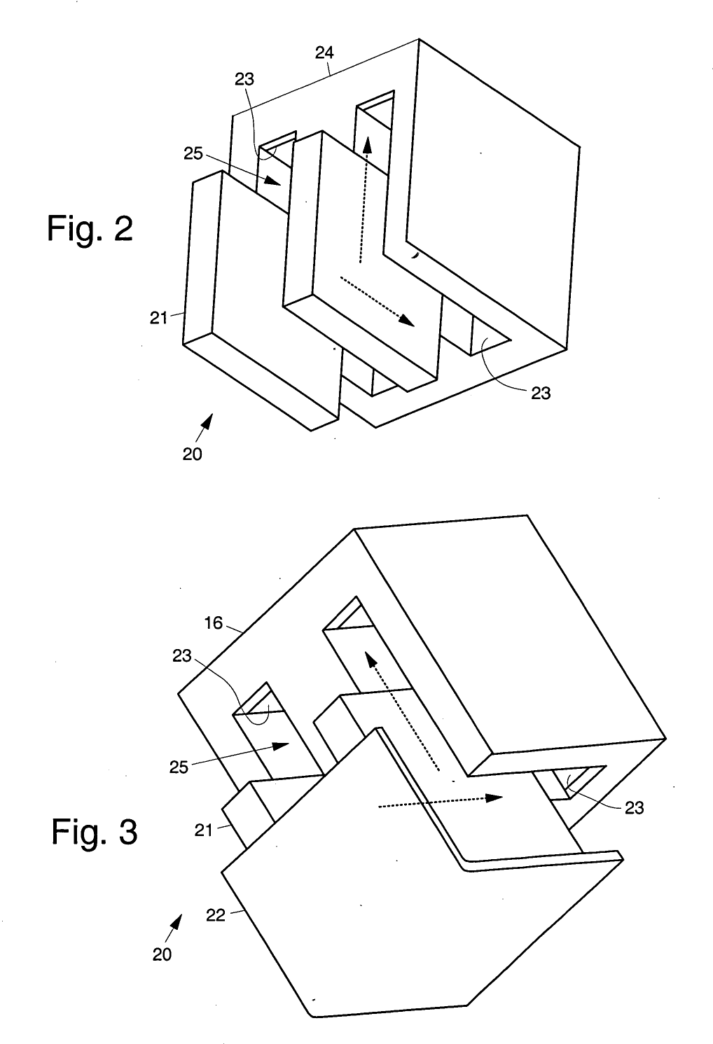

FIG. 2 illustrates an exemplary multi-directional electrical interconnect device 20 that may be used in the computing system 10 shown in FIG. 1. FIG. 3 shows another view of the exemplary multi-directional electrical interconnect device 20.

As is shown in FIGS. 2 and 3, the exemplary multi-directional electrical interconnect device 20 comprises one or more, and preferably a pair of conductive male terminals 21 disposed in, attached to, or coupled to a male terminal housing 22 (FIG. 3), and one or more, and preferably a pair of conductive female terminals 23 disposed in one or more cavities 25 formed in a female terminal housing 24. Exemplary male terminals 21 comprise blade-shaped conductive material. The blade-shaped conductive material may vary from relatively thin to relatively thick, depending upon the design of the device 20. The female terminals 23 comprise conductive sockets located adjacent to the inner walls of the female terminal housing 24 within the cavities 25. The male and female terminals 21, 23 are secured in place by their respective housings 22, 24.

The male and female housing 22, 24 are designed to allow multi-directional insertion of the male terminals 21 into the female terminals 23 from a direction that is within a 90 degree angular limit. In particular, the male terminals 21 may be inserted into the female terminals 23 from any angle between two right angle directions. In the context of assembling the fan module 15 in the computing system 10, this allows the fan module 15 to be inserted either from the top of the computing system 10, from the side of the computing system 10, or from any angle between these two directions, as a function of the orientation of the female terminals 23 and female terminal housing 24 relative to the male terminals 21. The multi-directional electrical interconnect device 20 thus permits electrical connection from two directions that are disposed 90 degrees relative to each other, or from any angle between these two directions, as is illustrated in FIGS. 2 and 3.

The female terminals 23 reside inside the female connector housing 24. The female connector housing 24 may accept the male terminals 21 from any angle between the two directions, 90 degrees opposed as is illustrated by the dashed arrows shown in FIGS. 2 and 3.

It should be clear from FIGS. 2 and 3 that the exemplary multi-directional electrical interconnect device 20 allows electrical connection to be made in either of two directions, 90 degrees opposed, or from an angle that is between the two directions. The multi-directional electrical interconnect device 20 solves the problem illustrated in FIG. 1 and allows the same fan module 11 to be installed from both the side and the top of the computing system 10 without the need for a different connector.

The above-described exemplary multi-directional electrical interconnect device allows for a single fan module, for example, to be used in two different configurations, thus reducing the number of unique parts required by the computing system 20. This represents a significant cost savings in many situations.

Thus, a multi-directional electrical interconnect device been disclosed that permits mating and interconnection in between two right angles. It is to be understood that the above-described embodiment is merely illustrative of some of the many specific embodiments that represent applications of the principles described herein. Clearly, numerous and other arrangements can be readily devised by those skilled in the art without departing from the scope of the invention.

What is claimed is:

1. Electrical interconnect apparatus comprising:
a first terminal housing;
one or more first conductive terminals attached to the first terminal housing;
a second terminal housing having one or more cavities formed therein; and
one or more second conductive terminals disposed in the one or more cavities of the second terminal housing that are configured to mate with respective first conductive terminals;
wherein the one or more first terminals are operative to mate with the one or more second terminals when they are mated at any angle between two directions that are disposed at 90 degrees relative to one another, so as to form a multi-directional electrical interconnect device.

2. The apparatus recited in claim 1 wherein the one or more first conductive terminals comprise blade-shaped conductive material.

3. The apparatus recited in claim 1 wherein the one or more second conductive terminals comprise conductive sockets.

4. The apparatus recited in claim 2 wherein the one or more second conductive terminals comprise conductive sockets.

5. Electrical interconnect apparatus comprising:
first housing means;
first conductive means attached to the first housing means;
second housing means having one or more cavities formed therein; and
second conductive means disposed in the one or more cavities of the second housing means that are configured to mate with respective first conductive means;
wherein the first conductive means are operative to mate with the second conductive means when they are mated at any angle between two directions that are disposed at 90 degrees relative to one another.

6. The apparatus recited in claim 5 wherein the one or more first conductive means 21 comprise blade-shaped conductive material.

7. The apparatus recited in claim 5 wherein the second conductive means comprise conductive sockets.

8. The apparatus recited in claim 6 wherein the second conductive means comprise conductive sockets.
